(19) United States
(12) Patent Application Publication
(10) Pub. No.: US 2010/0095001 A1
(43) Pub. Date: Apr. 15, 2010

(54) GATEWAY SERVICE METHOD APPLIED IN OPEN SERVICES GATEWAY INITIATIVE AND DEVICE AND GATEWAY SYSTEM USING THE SAME

(75) Inventors: Hsia-Hsin Li, Hsinchu City (TW); Cheng-Yu Wu, Hualien County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/409,803

(22) Filed: Mar. 24, 2009

(30) Foreign Application Priority Data
Oct. 14, 2008 (TW) 97139442

(51) Int. Cl. G06F 15/16

(52) U.S. Cl. 709/226

(57) ABSTRACT

A gateway service method applied in a gateway device of OSGi is provided. The method includes obtaining at least an identification information of at least a client device; communicating with at least a service supplier according to the identification information; obtaining at least an OSGi bundle corresponding to the client device and supplied by the service supplier; and processing the OSGi bundle to supply service to the client device.

This application claims the benefit of Taiwan application Serial No. 97139442, filed Oct. 14, 2008, the subject matter of which is incorporated herein by reference.

### BACKGROUND OF THE INVENTION

1. Field of the Invention

The invention relates in general to a gateway service method, and more particularly to a gateway service method applied in open services gateway initiative (OSGi) and gateway device and system using the same.

2. Description of the Related Art

The OSGi is a non-profit organization set up since 1999, aimed at constructing an open service initiative and a common standard for the technique of supplying the required service to the client devices via network. That is, the OSGi defines an open platform.

Under this platform, when the user operates a client device, the user can communicate with the OSGi gateway device so as to communicate with a service supplier set up by the supplier, which provides the client device, and download application programs or other application information therefrom. Therefore, in the conventional OSGi gateway system, the user must obtain the service by himself/herself from the service supplier, which restricts the type of available service. As a result, how to enable the client device to obtain more diverse and helpful services for users through the gateway device is a target of the relevant industrial's endeavor.

### SUMMARY OF THE INVENTION

Consistent with the invention, there is provided a gateway service method applied in OSGi and gateway device and system using the same such that the client device can obtain more diverse and helpful services for users.

Consistent with the invention, there is provided a gateway service method is provided. The gateway service method is applied in a gateway device of OSGi. The method comprises obtaining at least an identification information of at least a client device; communicating with at least a service supplier according to the identification information; obtaining at least an OSGi bundle corresponding to the client device and supplied by the service supplier; and processing the OSGi bundle to supply service to the client device.

Also consistent with the invention, there is provided a gateway device applied in OSGi is provided. The gateway device includes a processor and a storage unit. The processor is for operating in an OSGi framework to obtain an identification information of at least a client device and communicating with at least a service supplier according to the identification information and for obtaining at least an OSGi bundle corresponding to the client device and supplied by the service supplier, wherein the processor processes the OSGi bundle to supply service to the client device. The storage unit is for storing the OSGi bundle.

Further, and consistent with the invention, there is provided a gateway system applied in OSGi is provided. The gateway system comprises a service supplier and an OSGi gateway device. The service supplier is for supplying at least an OSGi bundle corresponding to at least a client device. The OSGi gateway device comprises a processor and a storage unit. The processor is for operating in an OSGi framework to obtain an identification information of the client device and communicating with the service supplier according to identification information, and for obtaining the OSGi bundle corresponding to the client device and supplied by the service supplier, wherein the processor processes the OSGi bundle to supply service to the client device. The storage unit is for storing the OSGi bundle.

It is to be understood that both the foregoing general description and the following detailed description are exemplary and explanatory only and are not restrictive of the invention, as claimed.

### BRIEF DESCRIPTION OF THE DRAWINGS

FIG. 1 is a flow chart of a gateway service method according to an exemplary embodiment consistent with the invention.

FIG. 2 is a block diagram of an OSGi gateway system according to an exemplary embodiment consistent with the invention.

### DETAILED DESCRIPTION OF THE INVENTION

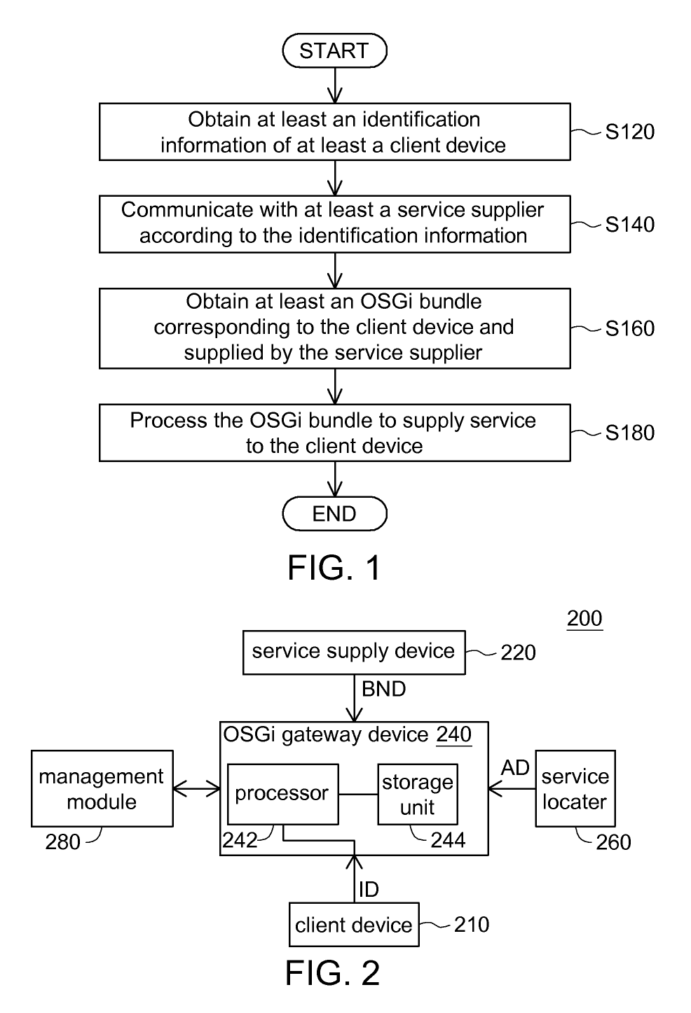

Referring to FIG. 1, a flow chart of a gateway service method according to an exemplary embodiment consistent with the invention is shown. The method is applied in a gateway device of OSGi. The method includes the following steps. In step S120, obtain at least an identification information of at least a client device. In step S140, communicate with at least a service supplier according to the identification information. In step S160, obtain at least an OSGi bundle corresponding to the client device and supplied by the service supplier. In step S180, process the OSGi bundle to supply service to the client device. In the following description, an OSGi gateway system applying the method is used to further illustrate the invention.

Referring to FIG. 2, a block diagram of an OSGi gateway system 200 according to an exemplary embodiment consistent with the invention is shown. The OSGi gateway system 200 includes a service supplier 220, an OSGi gateway device 240, a service locater 260 and a management module 280. The service supplier 220 is used for supplying at least an OSGi bundle BND corresponding to at least a client device 210. The OSGi gateway device 240 includes a processor 242 and a storage unit 244. The processor 242 is for operating in an OSGi framework in order to execute the OSGi gateway service method as shown in FIG. 1.

The processor 242 obtains the identification information ID of the client device 210. For example, in FIG. 2, the processor 242 obtains the identification information ID of the client device 210 via a communication connection. The communication connection is one of infrared communication or blue-tooth communication for instance. In another application, the communication connection is a network communication applying transmission control protocol/internet protocol (TCP/IP). However, the invention is not limited thereto. As long as the gateway device 240 can obtain the identification information ID of the client device 210 by a wiring or wireless way, all the alternatives are not apart from the scope of the invention.

When the processor 242 obtains the identification information ID, the processor 242 determines whether the client device 210 is a device capable of using the gateway service method according to the identification information ID. If the client device 210 is determined incapable of using the gateway service method, the processor 242 ends up the following operations.

When the processor 242 determines the client device 210 is a device capable of using the gateway service method according to the identification information ID, the processor 242 further communicates with the service supplier 220 according to the identification information ID. For example, the identification information ID may be a serial number of the client device 210, or any information capable of identifying the client device 210. The service supplier 220 may be exemplified as a server set up by the supplier selling the client device 210, or a server set up by a professional factory providing the relevant services for the client device 210.

In the following description, how the processor 240 of the OSGi gateway device 240 communicates with the service supplier 220 according to the identification information ID is illustrated. In one embodiment, the OSGi gateway device 240 communicates with the service supplier 220 according to the identification information ID via the service locater 260. In this embodiment, the service locater 260 is, for example, a server storing an address AD. The address AD corresponds to the service supplier 220. When the OSGi gateway device 240 communicates with the service supplier 220 according to the identification information ID, the OSGi gateway device 240 obtains the address AD corresponding to the service supplier 220 by inquiring the service locater 260, and thus communicates with the service supplier 220 according to the address AD. In practical application, the address AD is, for example, an IP address of the service supplier 220. Therefore, the OSGi gateway device 240 can perform a network communication connection with the service supplier 220 according to the IP address, so as to achieve the purpose of communicating with the service supplier 220.

Continuously referring to FIG. 2, after the OSGi gateway device 240 communicates with the service supplier 220, the processor 242 obtains the OSGi bundle BND corresponding to the client device 210 and supplied by the service supplier 220. The storage unit 244 is for storing the OSGi bundle BND. Next, the processor 242 processes the OSGi bundle BND to supply service to the client device 210.

In one embodiment, the OSGi bundle BND includes a driving program of the client device 210. The processor 242 executes the driving program to control the client device 210 to perform a specific function. For example, the client device 210 is a device having functions of blood-pressure, blood-sugar (a.k.a. blood glucose), heartbeat, electrocardiogram (ECG) or other medical-treatment measurement. Preferably, the client device 210is a portable device having the above functions. The specific function is to perform the above blood-pressure, blood-sugar, electrocardiogram or other medical-treatment measurement for the users using the client device 210.

To describe in detailed, when the OSGi gateway device 240 processes the bundle BND to control the client device 210 to perform the function of medical-treatment measurement, the OSGi device 240 can serve as a communication relay between the service supplier 220 and the client device 210 and thus the service supplier 220 can supply service to the client device 210 through the OSGi gateway device 240. For example, if the client device 210 has the function of blood-pressure measurement, the client device 210 can obtain the blood pressure of the user using the client device 210, and the OSGi gateway device 240 will transmit the blood pressure of the user to the service supplier 220. The service supplier 220 determines whether the blood pressure of the user is normal or not, and accordingly provides the user with the service of medical-treatment.

For example, the user may wear a portable device, such as the above client device 210. When the user suddenly suffers from a heart attack, the user might have got shocked and could not ask others for help. At the time, the OSGi gateway device can, for example, control the client device 210 to automatically measure at least one of the blood pressure, pulse and heartbeat of the user, and transmit the values up to the service supplier 220. Through the OSGi gateway device 240, the service supplier 220 obtains at least one of the blood pressure, pulse and heartbeat of the user detected by the portable device worn on the user, determines that the user's life function has become abnormal, and then can further ask for assistance timely from the relevant unit to provide the user with the emergency service of medical treatment, such as send an emergency staff to give the user first aid. Therefore, the gateway service method applied in an OSGi and the gateway device and gateway system using the same have substantial benefits on achieving the technique of domestic nursing or remote medical-treatment service.

In the above description, the client device 210 is exemplified to supply a professional service of medical treatment. However, the invention is not limited thereto. After processing the OSGi bundle BND, the processor 242 can further supply other types of service to the client device 210, such as updating software of the client device 210, or downloading multi-media data to the client device 210. That is, the OSGi gateway device can possess the ability of controlling the client device 210 after obtaining and processing the OSGi bundle BND, and thus the client device 210 can communicate with the service supplier 220 through the OSGi gateway device 240. Therefore, the OSGi gateway device 240 can obtain the service information, which can be supplied to the client device 2101 from network and actively supplies service to the client device 210.

In the above embodiment, the OSGi gateway device 240 obtains the OSGi bundle BND corresponding to the client device 210 and supplies the client device 210 with the required service through the same service supplier 220. However, the invention is not limited thereto. The OSGi gateway device 240 can also respectively obtain the OSGi bundle BND and supplying service through different service suppliers, such as different servers. That is, for example, the OSGi gateway device 240 can obtain the OSGi bundle BND corresponding to the client device 210 through the service supplier 220, and thus supply service to the client device 210 through another service supplier (not shown).

Besides, in one embodiment, the management module 280 of FIG. 2 is used for performing a fee-counting operation according to the service supplied to the client device 210 by the service supplier 220 when the OSGi gateway device 240 supplies service to the client device 210. The fee-counting operation includes fee or point deduction, and counting monthly or according to a contract set up by the user of the client device 210 and the supplier of the service supplier 220.

Additionally, in the OSGi gateway system provided by the above embodiment of the invention, the OSGi gateway device 240 is exemplified to inquire an external service locater 260. However, the invention is not limited thereto. The service locater 260 can also be disposed in the OSGi gateway device 240, i.e. the service locater 260 can also be included in the OSGi gateway device 240. In this way, when the OSGi gateway device communicates with the service supplier 220 according to the identification information ID, the OSGi gateway device 240 can obtain the address AD for communicating with the service supplier 220 by inquiring the internal service locater 260.

In the OSGi gateway system 200 provided by the above embodiment of the invention, the client device 210 is a portable electronic device for instance. When the user operates the portable electronic device, the OSGi gateway device 240 can communicate with the client device and the service supplier and actively supply service as long as the portable electronic device is located within an available service range of the OSGi gateway device 240.

The gateway service method applied in OSGi and the gateway device and system using the same disclosed by the embodiment of the invention enables the client device to obtain more diverse and helpful services for the user through the gateway device by obtaining the identification information of the client device. Further, the OSGi gateway device provided by the embodiment of the invention is not limited to using the TCP/IP network communication connection, but can also use the infrared or blue-tooth communication connection for communicating with the client device. Therefore, when the client device is located within the available service range of the OSGi gateway device, the OSGi gateway device can communicate with the client device through infrared or blue-tooth communication, and actively supply service to the client device. The invention has substantial benefits on achieving the technique of domestic nursing or remote medical-treatment service.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A gateway service method, applied in a gateway device of open services gateway initiative (OSGi), the method comprising:
obtaining at least an identification information of at least a client device;
communicating with at least a service supplier according to the identification information;
obtaining at least an OSGi bundle corresponding to the client device and supplied by the service supplier; and
processing the OSGi bundle to supply service to the client device.

2. The method according to claim 1, wherein the step of communicating with the service supplier according to the identification information comprises:
obtaining an address corresponding to the service supplier according to the identification information by inquiring a service locater; and
communicating with the service supplier according to the address.

3. The method according to claim 1, wherein the OSGi bundle comprises a driving program of the client device and the step of processing the OSGi bundle to supply service to the client device comprises:
executing the driving program to control the client device to perform a specific function.

4. The method according to claim 1, wherein the step of supplying service further comprises:
performing a fee-counting operation by an management module according to the service supplied to the client device by the service supplier.

5. The method according to claim 1, wherein the step of obtaining the identification information of the client device further comprises:
obtaining the identification information of the client device via a communication connection.

6. The method according to claim 5, wherein the communication connection is one of an infrared communication and a blue-tooth communication.

7. The method according to claim 5, wherein the communication connection is a network communication applying transmission control protocol/internet protocol (TCP/IP).

8. The method according to claim 1, wherein after obtaining the identification information, the method further comprises:
determining whether the client device is a device capable of using the gateway service method according to the identification information, and if not, ending the method.

9. A gateway device applied in open services gateway initiative (OSGi), comprising:
a processor, for operating in an OSGi framework to obtain an identification information of at least a client device and communicating with at least a service supplier according to the identification information and for obtaining at least an OSGi bundle corresponding to the client device and supplied by the service supplier, wherein the processor processes the OSGi bundle to supply service to the client device; and
a storage unit, for storing the OSGi bundle.

10. The gateway device according to claim 9, further comprising:
a service locater, for storing an address corresponding to the service supplier;
wherein when the processor communicates with the service supplier according to the identification information, the processor obtains the address corresponding to the service supplier according to the identification information by inquiring the service locater, and communicates with the service supplier according to the address.

11. The gateway device according to claim 9, wherein the OSGi bundle comprises a driving program of the client device, when the processor processes the OSGi bundle, the processor executes the driving program to control the client device to perform a specific function.

12. The gateway device according to claim 9, wherein when the processor obtains the identification information of the client device, the processor obtains the identification information of the client device via a communication connection.

13. The gateway device according to claim 12, wherein the communication connection is one of an infrared communication and a blue-tooth communication.

14. The gateway device according to claim 12, wherein the communication connection is a network communication applying transmission control protocol/internet protocol (TCP/IP).

15. The gateway device according to claim 9, wherein after obtaining the identification information, the processor further determines whether the client device is a device capable of using the gateway service method according to the identification information, and ends up the following operations if the client device is determined incapable of using the gateway service method.

16. The gateway device according to claim 9, wherein the client device is a portable electronic device.

17. A gateway system applied in open services gateway initiative (OSGi), comprises:
a service supplier, for supplying at least an OSGi bundle corresponding to at least a client device; and
an OSGi gateway device, comprising:
a processor, for operating in an OSGi framework to obtain an identification information of the client device and communicating with the service supplier according to the identification information, and for obtaining the OSGi bundle corresponding to the client device and supplied by the service supplier, wherein the processor processes the OSGi bundle to supply service to the client device; and
a storage unit, for storing the OSGi bundle.

18. The gateway system according to claim 17, further comprising:
a service locater, for storing an address corresponding to the service supplier;
wherein when the gateway device communicates with the service supplier according to the identification information, the gateway device obtains the address corresponding to the service supplier according to the identification information by inquiring the service locater, and communicates with the service supplier according to the address.

19. The gateway system according to claim 17, wherein the OSGi gateway device further comprises:
a service locater, for storing an address corresponding to the service supplier;
wherein when the processor communicates with the service supplier according to the identification information, the processor obtains the address corresponding to the service supplier according to the identification information by inquiring the service locater, and communicates with the service supplier according to the address.

20. The gateway system according to claim 17, wherein the OSGi bundle comprises a driving program of the client device, the processor further executes the driving program to control the client device to perform a specific function.

21. The gateway system according to claim 20, further comprising:
an management module, for performing a fee-counting operation according to the service supplied to the client device by the service supplier when the getaway device supplies service to the client device.

22. The gateway system according to claim 17, wherein when the processor obtains the identification information of the client device, the processor obtains the identification information of the client device via a communication connection.

23. The gateway system according to claim 22, wherein the communication connection is one of an infrared communication and a blue-tooth communication.

24. The gateway system according to claim 22, wherein the communication connection is a network communication applying transmission control protocol/internet protocol (TCP/IP).

25. The gateway system according to claim 17, wherein after obtaining the identification information, the processor further determines whether the client device is a device capable of using the gateway service method according to the identification information, and ends up the following operations if the client device is determined incapable of using the gateway service method.

26. The gateway system according to claim 17, wherein the client device is a portable electronic device.
